(19) United States
(12) Patent Application Publication
(10) Pub. No.: US 2007/0245126 A1
(43) Pub. Date: Oct. 18, 2007

(54) Program counter of microcontroller and control method thereof

(75) Inventors: Sungdae Choi, Daejeon (KR); Hyejung Kim, Daejeon (KR); Hoi-Jun Yoo, Daejeon (KR)

Correspondence Address: OLIFF & BERRIDGE, PLC, P.O. BOX 19928, ALEXANDRIA, VA, 22320, US

(73) Assignee: KOREA ADVANCED INSTITUTE OF SCIENCE AND TECHNOLOGY, DAEJEON (KR)

(21) Appl. No.: 11/783,415

(22) Filed: Apr. 9, 2007

(30) Foreign Application Priority Data
Apr. 13, 2006 (KR) 2006-33565

(51) Int. Cl. G06F 9/40

(52) U.S. Cl. 712/205

(57) ABSTRACT

A program counter of a microcontroller and a method for controlling the same are disclosed. The program counter receives an external input program count indicating an address of a program to be executed by the microcontroller when the microcontroller wakes up out of a power-save/sleep mode, whereby the microcontroller can execute a desired program directly upon waking up without additionally performing an internal initialization process. Therefore, a system can wake up immediately while minimizing leakage power to reduce overall power consumption and time required for waking up.

### BACKGROUND OF THE INVENTION

1. Field of the Invention

The present invention relates to a program counter of a microcontroller and a control method thereof, and more particularly to a program counter of a microcontroller capable of receiving an external input program count indicating an address of a program to be executed by the microcontroller when the microcontroller wakes up out of a power-save/sleep mode, whereby the microcontroller can execute a desired program directly upon waking up without additionally performing an internal initialization process.

2. Description of the Related Art

A program counter is used to indicate an address of the next instruction to be executed by a microcontroller or microprocessor so that instructions stored in a program memory are executed sequentially. The program counter is incremented one by one every time the microcontroller fetches an instruction, to indicate an address of the next instruction to be executed by the microcontroller.

Recently, a microcontroller for a mobile device is set to be switched from a normal operation mode to a sleep mode or a power-save mode when the microcontroller is not used, in order to prevent power consumption.

In the sleep mode of the microcontroller, operational power consumption can be reduced by preventing clocks from being applied to the microcontroller while stopping its operations. However, leakage power is generated since power is still applied.

Further, in the power-save mode of the microcontroller, power consumption can be further reduced by interrupting the power supply. However, since an internal register value of the microcontroller is lost in the power-save mode, the internal register value has to be stored in an additional memory by performing a back-up operation before entering the power-save mode. Also, it is necessary to fetch the internal register value for initialization when the microcontroller wakes up. Thus, time required for waking up becomes longer and power consumption increases due to the above operations.

### SUMMARY OF THE INVENTION

Therefore, the present invention has been made in view of the above problems, and it is an object of the present invention to provide a program counter of a microcontroller capable of receiving an external input program count indicating an address of a program to be executed by the microcontroller when the microcontroller wakes up out of a power-save/sleep mode, whereby the microcontroller can execute a desired program directly upon waking up without additionally performing an internal initialization process.

In accordance with an aspect of the present invention, the above and other objects can be accomplished by the provision of a program counter of a microcontroller comprising: an external device for storing and providing a program count indicating an address of an instruction to be executed by the microcontroller when the microcontroller wakes up; and a program count generator for outputting the program count provided from the external device or internally generating a program count indicating an address of an instruction to be executed by the microcontroller.

In accordance with another aspect of the present invention, there is provided a method of controlling a program counter of a microcontroller, comprising: receiving an external input program count when the microcontroller wakes up; executing an instruction at an address indicated by the external input program count; and entering a low-power mode after executing the instruction at the address indicated by the external input program count.

Preferably, the low-power mode is a power-save mode or a sleep mode.

As described above, in accordance with the present invention, there is provided a program counter of a microcontroller capable of receiving both a program count provided from an external device and an internally generated program count, wherein the program count indicates an address of the next instruction to be executed by the microcontroller, so that the microcontroller can execute a desired program directly upon waking up without additionally performing an internal initialization process. Accordingly, a system can wake up immediately while minimizing leakage power. Therefore, overall power consumption can be further reduced and time required for waking up can be shortened.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing a configuration of a program counter of a microcontroller in accordance with the present invention; and

FIG. 2 is a block diagram showing a configuration of a program memory operated by performing a control method of the program counter of the microcontroller in accordance with the present invention.

### DETAILED DESCRIPTION OF THE PREFERRED EMBODIMENTS

Hereinafter, a preferred embodiment of the present invention will be described with reference to accompanying drawings, in which like reference numerals designate like parts having practically the same functions.

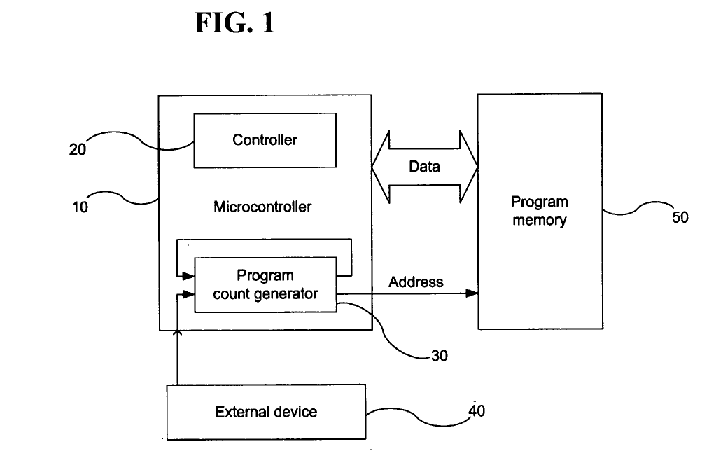

FIG. 1 is a block diagram showing a configuration of a program counter of a microcontroller in accordance with the present invention.

As shown in FIG. 1, the program counter in accordance with the present invention includes an external device 40 and a program count generator 30. The external device 40 stores a program count indicating an address of instruction to be executed by a microcontroller 10 when it wakes up and provides the program count to the program count generator 30. The program count generator 30 outputs the program count provided from the external device 40 or internally generates a program count indicating an address of instruction to be executed by the microcontroller 10. Thus, the program count generator 30 selectively receives two kinds of program counts (i.e., the internally generated program count and the program count provided from the external device 40), each program count indicating an address of instruction stored in a program memory 50. Then, a controller 20 fetches the instruction at the address in a program memory 50, which is indicated by the program count generator 30. The controller 20 executes instructions sequentially and the program count generator 30 is incremented one by one every time the controller 20 fetches an instruction, to indicate an address of the next instruction to be executed by the controller 20.

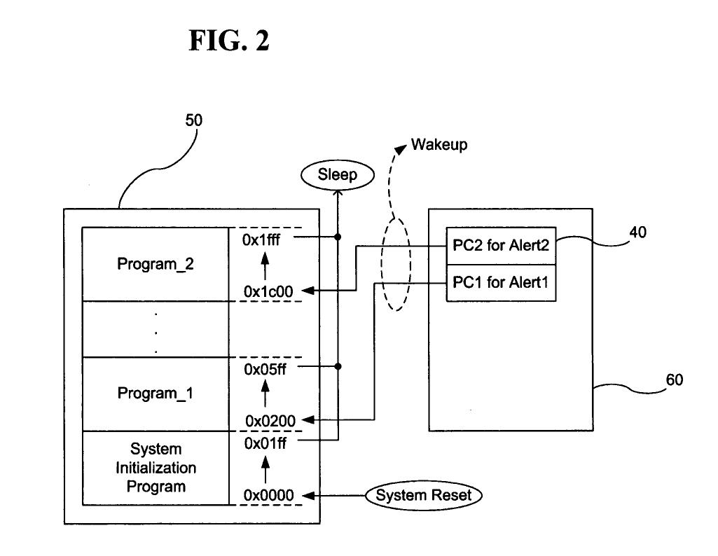

FIG. 2 is a block diagram showing a configuration of a program memory operated by performing a control method of the program counter of the microcontroller in accordance with the present invention.

As shown in FIG. 2, when a system is reset, the microcontroller 10 executes a system initialization program at an address 0x0000 corresponding to an initial program count that is internally generated and then enters a sleep mode (or a power-save mode) to prevent power consumption.

Thereafter, while an external device 60 wakes up the microcontroller 10, namely while the external device 60 supplies power to the microcontroller 10, the external device 40 provides a program count PC1 corresponding to an address 0x0200 to the microcontroller 10. Upon waking up, the microcontroller 10 executes Program_{—}1 at the address 0x0200 directly without initializing an internal register and enters the sleep mode again.

If the external device 40 provides a program count PC2 corresponding to an address 0x1c00 to the microcontroller 10 while the external device 60 wakes up the microcontroller 10, the microcontroller 10 executes Program_{—}2 at the address 0x1c00 and enters the sleep mode again.

As described above, in accordance with the present invention, there is provided a program counter of a microcontroller capable of receiving an external input program count indicating an address of a program to be executed by the microcontroller when the microcontroller wakes up out of a power-save/sleep mode, whereby the microcontroller can execute a desired program directly upon waking up without additionally performing an internal initialization process. Accordingly, a system can wake up immediately while minimizing leakage power. Therefore, overall power consumption can be further reduced and time required for waking up can be shortened.

Further, the program counter of the microcontroller in accordance with the present invention is particularly applicable for a mobile device, such as a cellular phone and a PDA, which requires an intermittent operation of the microcontroller. That is, the mobile device can be operated with good performance at low power by reducing time and operations required for waking up.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A program counter of a microcontroller comprising:
an external device for storing and providing a program count indicating an address of an instruction to be executed by the microcontroller when the microcontroller wakes up; and
a program count generator for outputting the program count provided from the external device or internally generating a program count indicating an address of an instruction to be executed by the microcontroller.

2. A method of controlling a program counter of a microcontroller, comprising:
receiving an external input program count when the microcontroller wakes up;
executing an instruction at an address indicated by the external input program count; and
entering a low-power mode after executing the instruction at the address indicated by the external input program count.

3. The method according to claim 2, wherein the low-power mode is a power-save mode or a sleep mode.
